(19) United States
(12) Patent Application Publication
(10) Pub. No.: US 2025/0291303 A1
(43) Pub. Date: Sep. 18, 2025

(54) IMAGE FORMING APPARATUS

(71) Applicant: CANON KABUSHIKI KAISHA, Tokyo (JP)

(72) Inventors: MASAHIDE HIRAI, Shizuoka (JP); YOJI MISAO, Shizuoka (JP)

(21) Appl. No.: 19/077,717

(22) Filed: Mar. 12, 2025

(30) Foreign Application Priority Data
Mar. 13, 2024 (JP) 2024-038701

(51) Int. Cl. G03G 21/16; G03G 21/18

(52) U.S. Cl. CPC G03G 21/1633; G03G 21/1853

(57) ABSTRACT

An image forming apparatus includes an apparatus body, a cartridge, a first unit being movable to a first inner position inside of the apparatus body and a first outer position outside of the apparatus body relative to the apparatus body, and a second unit including a toner conveyance path and a conveying member configured to convey toner in the conveyance path, the second unit being movable to a second inner position inside of the apparatus body and a second outer position outside of the apparatus body relative to the apparatus body, a lifetime of the second unit is longer than a lifetime of the cartridge, and when the first unit moves from the first inner position to the first outer position, the second unit also moves from the second inner position to the second outer position.

### BACKGROUND

### Field

The present disclosure relates to an image forming apparatus that forms an image on a recording material.

### Description of the Related Art

Some image forming apparatuses, such as printers, copiers, and multifunction machines, have a detachably mounted cartridge on a tray that moves between the inside and outside of an apparatus body (Japanese Patent Application Publication No. 2010-244018). Some image forming apparatuses have a transfer unit that is movable between the inside and outside of the apparatus body in addition to the cartridge (Japanese Patent Application Publication No. 2015-206897). The cartridge and the transfer unit are replaced when the cartridge and the transfer unit reach the end of lifetime based on a degree of wear of constituent members estimated from, for example, the number of printed sheets.

### SUMMARY

The transfer unit may be provided with a collection mechanism for collecting so-called transfer residual toner or the like that remains on a transfer member (for example, an intermediate transfer belt) without being transferred to a recording material when a toner image is transferred to the recording material. From the viewpoint of maintainability, the collection mechanism is required to maintain collection performance throughout the lifetime of the transfer unit. The collection performance of the collection mechanism varies depending on an environment or conditions in which the apparatus is used. In particular, clogging of the toner in a conveyance path for the toner removed from the transfer member or hardening of the toner increases a load on a drive member such as a conveying member.

An object of the present disclosure is to provide a technology capable of curbing an increase in a load of a drive member such as a conveying member.

In order to achieve the above object, the image forming apparatus of the present disclosure for forming an image on a recording material includes an apparatus body; a cartridge; a first unit to which the cartridge is detachably attached, the first unit being movable to a first inner position inside of the apparatus body and a first outer position outside of the apparatus body relative to the apparatus body; and a second unit including a toner conveyance path and a conveying member configured to convey toner in the conveyance path, the second unit being movable to a second inner position inside of the apparatus body and a second outer position outside of the apparatus body relative to the apparatus body, wherein a lifetime of the second unit is longer than a lifetime of the cartridge, and in a case where the first unit moves from the first inner position to the first outer position, the second unit also moves from the second inner position to the second outer position.

According to the present disclosure, it is possible to curb the increase in the load of the drive member such as the conveying member.

Further features of various embodiments of the present disclosure will become apparent from the following description of exemplary embodiments with reference to the attached drawings.

### BRIEF DESCRIPTION OF THE DRAWINGS

FIG. 1 is an illustrative diagram of an overall configuration of a printer in Example 1;

FIG. 2 is a diagram illustrating the printer in a state where a door is open in Example 1;

FIG. 3 is an illustrative diagram when a transfer unit and a tray unit are pulled out in Example 1;

FIG. 4 is an illustrative diagram of a state where the transfer unit alone is pulled out in Example 1;

FIG. 5 is an illustrative diagram of a connection member that connects the tray to the transfer unit in Example 1;

FIG. 6 is an illustrative diagram of a connection member that connects the tray to the transfer unit in Example 1;

FIG. 7 is an illustrative diagram of a connection member that connects the tray to the transfer unit in Example 1;

FIG. 8 is an illustrative diagram of torque change;

FIG. 9 is an illustrative diagram of a transfer unit in Example 2;

FIG. 10 is an illustrative diagram of the transfer unit in Example 2;

FIG. 11 is an illustrative diagram of a toner state in Example 2;

FIG. 12 is an illustrative diagram of torque change in Example 2;

FIG. 13 is a diagram illustrating a printer in a state where a door is open in Example 3;

FIG. 14 is an illustrative diagram when a transfer unit and a tray unit are pulled out in Example 3;

FIG. 15 is a perspective view illustrating insertion and removal of a transfer unit 40 in Example 4;

FIGS. 16A to 16D are illustrative diagrams of a tray unit of a modification example; and

FIG. 17 is an illustrative diagram of a configuration in a comparative example.

### DESCRIPTION OF THE EMBODIMENTS

Hereinafter, modes for carrying out the present disclosure will be described in detail by way of example based on embodiments of the present disclosure with reference to the drawings. However, dimensions, materials, shapes, relative positions, and the like of components described in the present embodiments should be changed appropriately depending on a configuration of an apparatus to which the disclosure is applied, or various conditions. In other words, the scope of the present disclosure is not intended to be limited to the following embodiments. Further, not all of characteristics described in the following embodiments are necessarily essential to a solution of the disclosure.

### Example 1

### Overall Configuration

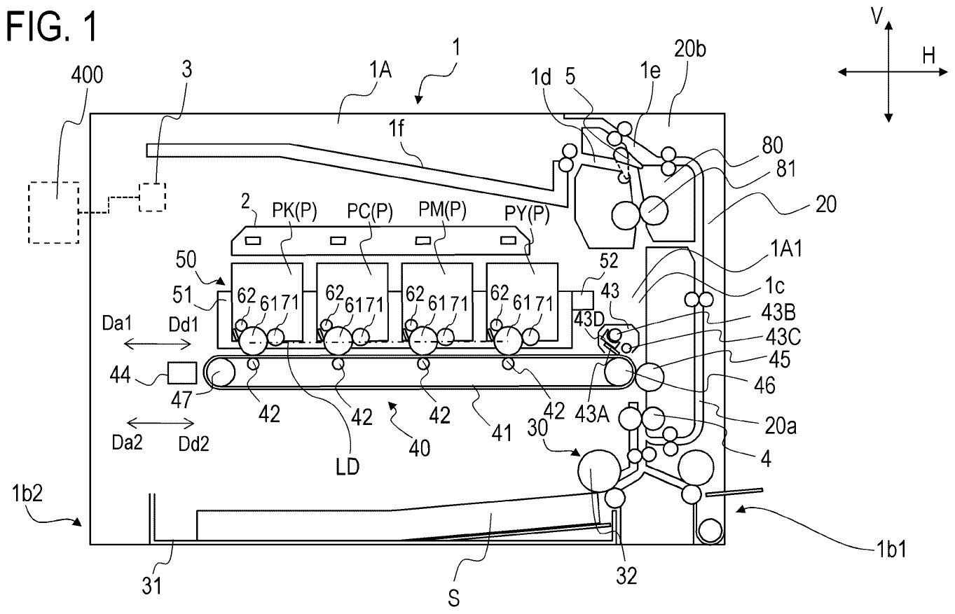

A printer 1 will be described as an image forming apparatus with reference to FIG. 1. FIG. 1 is a diagram illustrating an overall configuration of the printer 1 according to the present example. In the present example, the printer 1 is an electrophotographic color laser beam printer that forms an image on a sheet S as a recording material. In each figure including FIG. 1, an arrow V indicates a vertical direction (gravity direction) and an arrow H indicates a horizontal direction and indicates a normally assumed installation state of the printer 1, which is a state where the printer 1 is placed on a horizontal installation surface.

The printer 1 includes an apparatus body (housing) 1A, a scanner (exposure apparatus) 2, a control portion 3, and a door (opening and closing member) 20 that can be opened and closed relative to the apparatus body 1A. Further, the printer 1 includes a sheet feeding portion 30, a transfer unit (transfer apparatus) 40, a tray unit (moving unit or support unit) 50, and a fixing apparatus 80.

The apparatus body 1A accommodates the scanner 2, the control portion 3, the sheet feeding portion 30, the transfer unit 40, the tray unit 50, and the fixing apparatus 80.

The sheet feeding portion 30 includes a loading tray 31 for loading the sheet S, and a supply roller 32. The loading tray 31 can be pulled out toward a door 20 so that sheets S can be replenished.

The tray unit 50 includes a tray (support member) 51 and cartridges PY, PM, PC, and PK, and the tray 51 has a tray handle 52. The cartridges PY, PM, PC, and PK are detachably attached on the tray 51.

The cartridges PY, PM, PC, and PK are each attachable to and detachable from the tray 51 independently of each other. The cartridges PY, PM, PC, and PK accommodate yellow (Y), magenta (M), cyan (C), and black (K) toners (developers), respectively. The cartridges PY, PM, PC, and PK have the same configuration except for the color of toner the cartridges PY, PM, PC, and PK accommodate. Therefore, a configuration and operation of one of the cartridges PY, PM, PC, and PK will be described, and description of the others will be omitted. Also, when there is no need to distinguish between the cartridges PY, PM, PC, and PK, the cartridges PY, PM, PC, and PK may be simply called a cartridge P. The tray unit 50 can be said to include a plurality of cartridges P and a tray 51 on which the plurality of cartridges P are detachably mounted.

In the present example, the tray unit 50 includes a plurality of photosensitive drums (photoconductors or image bearing members) 61, a plurality of charging rollers 62 (charging members), and a plurality of developing rollers (developer bearing members) 71. Specifically, the tray unit 50 has four photosensitive drums 61, four charging rollers 62, and four developing rollers 71. The rotation axis directions of the photosensitive drums 61, the developing rollers 71, and the charging rollers 62 are parallel to one another.

A portion that forms a black (K) image is called a black station (first station), the photosensitive drum 61 of the first station is called a first photosensitive drum, the developing roller 71 is called a first developing roller, and the charging roller 62 is called a first charging roller. A portion that forms a cyan (C) image is called a cyan station (second station), the photosensitive drum 61 of the second station is called a second photosensitive drum, the developing roller 71 is called a second developing roller, and the charging roller 62 is called a second charging roller. A portion that forms a magenta (M) image is called a magenta station (third station), the photosensitive drum 61 of the third station is called a third photosensitive drum, the developing roller 71 is called a third developing roller, and the charging roller 62 is called a third charging roller. A portion that forms a yellow (Y) image is called a yellow station (fourth station), the photosensitive drum 61 of the fourth station is called a fourth photosensitive drum, the developing roller 71 is called a fourth developing roller, and the charging roller 62 is called a fourth charging roller.

The cartridge PK is attached in the black station, the cartridge PC is attached in the cyan station, the cartridge PM is attached in the magenta station, and the cartridge PY is attached in the yellow station. In the present example, the cartridge PK is called a first cartridge, the cartridge PC is called a second cartridge, the cartridge PM is called a third cartridge, and the cartridge PY is called a fourth cartridge. The numbers first, second, third, and fourth are used for convenience in the description.

The photosensitive drum 61, the charging roller 62, and the developing roller 71 may be included in either the cartridge P or the tray 51. In the present example, the cartridge P includes the photosensitive drum 61, the charging roller 62, and the developing roller 71. In other words, the photosensitive drum 61 for bearing a toner image, and the charging roller 62 and the developing roller 71 for forming a toner image on the photosensitive drum 61, are configured as the cartridge P to be attachable to and detachable from the tray 51. A configuration of the cartridge P is not limited thereto. For example, the photosensitive drum 61 may be provided in the tray 51, and the charging roller 62, the developing roller 71, and the like constituting the toner image forming portion that forms the toner image on the photosensitive drum 61 may be configured as the cartridge P to be attachable to and detachable from the tray 51.

The transfer unit 40 includes a belt 41, a primary transfer roller 42, a cleaning portion 43, a drive roller 46 that drives the belt 41, and a tension roller (driven roller) 47. In the printer 1 of the present example, an optical sensor 44 that detects the toner image transferred to the belt 41 is disposed. In the present example, the belt 41 is disposed below the photosensitive drum 61 and can come into contact with the photosensitive drum 61 so that a primary transfer portion is formed between the belt 41 and the photosensitive drum 61. The printer 1 also includes a secondary transfer roller 45 that comes into contact with the belt 41 so that a secondary transfer portion is formed. The secondary transfer portion is formed between the belt 41 and the secondary transfer roller 45. A rotation axis direction of the primary transfer roller 42, a rotation axis direction of the drive roller 46, a rotation axis direction of a tension roller 47, and a rotation axis direction of the secondary transfer roller 45 are parallel to each other. A registration roller pair 4 is disposed in front of the secondary transfer portion.

The fixing apparatus 80 includes a fixing portion 81 and a flapper 5. In the present example, the fixing portion 81 includes a heating portion (heating roller) including a heater, and a pressure portion (pressure roller).

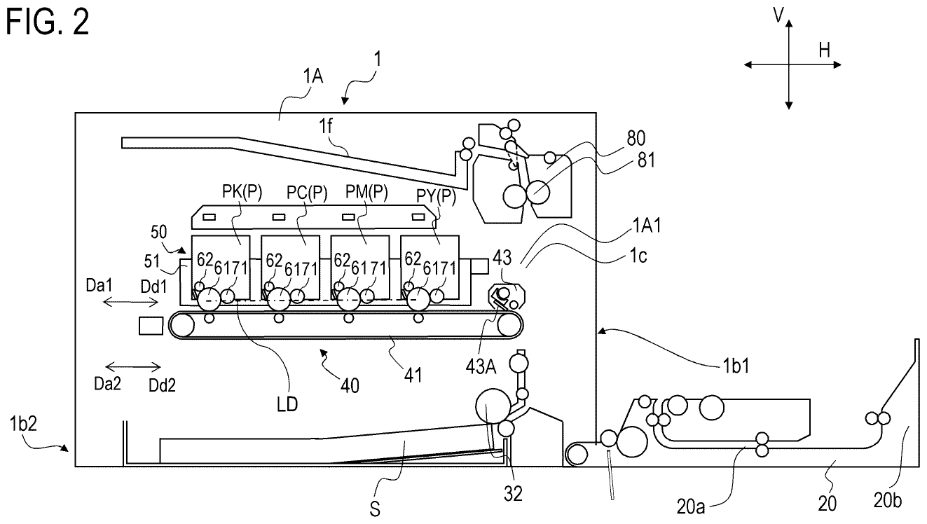

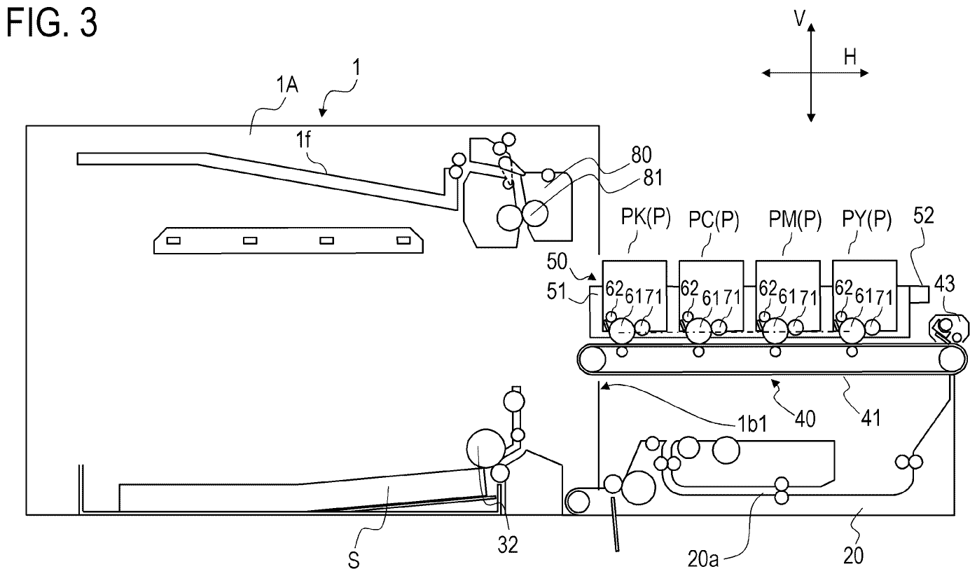

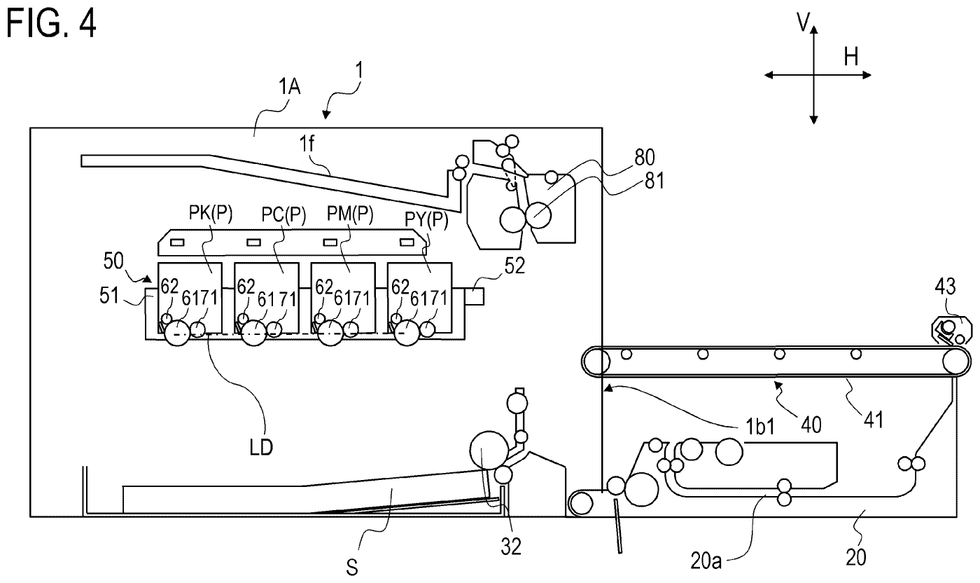

The movement of the transfer unit 40 and the tray unit 50 will be described using FIGS. 1, 2, 3, and 4. FIG. 2 is a diagram illustrating the printer 1 in a state where the door 20 is open. FIG. 3 is a diagram illustrating the printer 1 in a state where the transfer unit 40 and the tray unit 50 are pulled out. FIG. 4 is a diagram illustrating the printer 1 in a state where the transfer unit 40 alone is pulled out.

The transfer unit 40 and the tray unit 50 are movable from inside to outside of the apparatus body 1A. In a horizontal direction H, the apparatus body 1A includes a first end 1b1 with an opening 1A1, and a second end 1b2 opposite to the first end 1b1. The tray unit 50 is a first unit and is movable to a first inner position inside of the apparatus body 1A and a first outer position outside of the apparatus body 1A through the opening 1A1. The transfer unit 40 is a second unit and is movable to a second inner position inside of the apparatus body 1A and a second outer position outside of the apparatus body 1A through the opening 1A1.

A direction in which the tray unit 50 moves from the first inner position to the first outer position is called a first removal direction Dd1, and a direction opposite to the first removal direction Dd1 is called a first attachment direction Da1. The first removal direction Dd1 can be said to be a direction from the second end 1b2 to the first end 1b1.

A direction in which the transfer unit 40 moves from the second inner position to the second outer position is called a second removal direction Dd2, and a direction opposite to the second removal direction Dd2 is called a second attachment direction Da2. The second removal direction Dd2 can be said to be the direction from the second end 1b2 to the first end 1b1.

The first removal direction Dd1 and the first attachment direction Da1 are directions intersecting with a rotation axis direction of the photosensitive drum 61. The second removal direction Dd2 and the second attachment direction Da2 are directions intersecting with the rotation axis direction of the drive roller 46. The rotation axis direction of the drive roller 46 is parallel to the rotation axis direction of the photosensitive drum 61.

In the horizontal direction H, the fixing apparatus 80 is disposed on one end side (the side on which the first end 1b1 is disposed) of the apparatus body 1A.

The door 20 attached to the apparatus body 1A is an opening and closing member that is movable between a closed position at which the inside of the apparatus body 1A is closed with respect to the outside and an open position at which the inside of the apparatus body 1A is open with respect to the outside. As illustrated in FIG. 1, when the door 20 is at the closed position (a closed state of the door 20), the door 20 covers the opening 1A1. As illustrated in FIG. 2, when the door 20 is at the open position (an open state of the door 20), the opening 1A1 is exposed.

As illustrated in FIG. 1, when the door 20 is at the closed position, the door 20 covers the fixing apparatus 80 attached to the apparatus body 1A. More specifically, an upper cover portion 20b of the door 20 is located above the fixing apparatus 80 in a state where the door 20 is at the closed position. The upper cover portion 20b of the door 20 functions as a part of an exterior portion.

The door 20 is movable between the open position and the closed position in a state where the fixing apparatus 80 is supported by the apparatus body 1A. In other words, the door 20 moves from the closed position to the open position to move away from the fixing apparatus supported by the apparatus body 1A. Therefore, in a state where the door 20 is at the open position, the door 20 is away from the fixing apparatus 80 supported by the apparatus body 1A, as illustrated in FIG. 2.

When the tray unit 50 is moved to the outside of the apparatus body 1A (FIG. 3), the cartridges PY, PM, PC, and PK are permitted to be removed from the tray 51 and the cartridges PY, PM, PC, and PK are permitted to be attached to the tray 51. This allows the cartridges PY, PM, PC, and PK to be replaced with new cartridges PY, PM, PC, and PK. In the present example, the cartridge P is detachable from the tray 51 in a direction intersecting with (preferably, a direction perpendicular to) a rotation axis of the photosensitive drum 61.

The cartridges PY, PM, PC, and PK are removed from the tray 51 by moving in a direction away from the transfer unit 40 with respect to the tray 51. In other words, the cartridges PY, PM, PC, and PK are removed from the tray 51 by moving in a direction opposite to the transfer unit 40 with respect to the tray 51. In the present example, the transfer unit 40 is disposed below the tray unit 50. Therefore, the cartridges PY, PM, PC, and PK move upward relative to the tray 51 and are removed from the tray 51.

Further, as illustrated in FIG. 4, the transfer unit 40 can be removed from the apparatus body 1A independently of the tray unit 50, and can be replaced with a new transfer unit 40. The transfer unit 40 is configured to be moved from the second outer position to before the second inner position and then positioned at the second inner position at which the belt 41 comes into contact with each photosensitive drum 61 to form the primary transfer portion through an operation of closing the door 20.

### Image Forming Operation

An image forming operation of the printer 1 will be described with reference to FIG. 1. The control portion 3 of the printer 1 starts an image forming operation on the sheet S based on an image signal received from an external host apparatus 400. The external host apparatus 400 is, for example, a personal computer, an image reader, or a facsimile.

When an image is formed on the sheet S, the tray unit 50 is located at the first inner position, the transfer unit 40 is located at the second inner position, and the door 20 is located at the closed position. The belt 41 can come into contact with the photosensitive drum 61 in a state where the transfer unit 40 is at the second inner position. In this case, the tray unit 50 is located above the transfer unit 40.

A charging voltage is applied to the charging roller 62, and the photosensitive drum 61 rotates. The photosensitive drum 61 is irradiated with a laser corresponding to the image information from the scanner 2, and a surface of the photosensitive drum 61 charged by the charging roller 62 is exposed. Accordingly, an electrostatic latent image corresponding to the image information is formed on the surface of the photosensitive drum 61.

The developing roller 71 bears the toner. A developing voltage is applied to the developing roller 71, and the electrostatic latent image formed on the photosensitive drum 61 is developed by the toner supplied from the developing roller 71, and the toner image is formed on the surface of the photosensitive drum 61. In the present example, the developing roller 71 develops the electrostatic latent image in a state where the developing roller 71 is in contact with the photosensitive drum 61, but the developing roller 71 may develop the electrostatic latent image in a state where there is a gap between the developing roller 71 and the photosensitive drum 61. When a full-color image is formed, a toner image of each color is formed on each photosensitive drum 61.

In the present example, the developing roller 71 is movable between a contact position at which the developing roller 71 comes into contact with the photosensitive drum 61 and a spaced position at which the developing roller 71 is spaced from the photosensitive drum 61 in a state where the tray unit 50 is at the first inner position. Specifically, a switching device included in the apparatus body 1A switches between a state where the developing roller 71 is at the contact position and a state where the developing roller 71 is in the spaced position. This makes it possible for the developing roller 71 to be separated from the photosensitive drum 61 in a state where the image forming operation is not performed.

The printer 1 can perform monochrome printing in a state where the developing roller 71 corresponding to the cartridge PK comes into contact with the photosensitive drum 61, and the developing rollers 71 corresponding to the cartridges PY, PM, and PC are separated from the photosensitive drum 61. Further, the printer 1 can perform full-color printing in a state where the photosensitive drums 61 corresponding to the cartridges PY, PM, PC, and PK have come into contact with the belt 41.

The toner images formed on the respective photosensitive drums 61 are transferred onto the belt 41 by the primary transfer roller 42 in the primary transfer portion, and are conveyed toward the secondary transfer portion formed by the belt 41 and the secondary transfer roller 45.

Meanwhile, a conveyance path (a first path or a first conveyance path) 1c through which the sheet S directed to the fixing apparatus 80 passes is formed in the apparatus body 1A. Further, a double-sided conveyance path (a second path or a second conveyance path) 20a through which the sheet S that has passed through the fixing apparatus 80 passes is formed in the door 20. The door 20 covers a conveyance path 1c in a state where the door 20 is closed. When the door 20 is open, the conveyance path 1c and a double-sided conveyance path 20a are exposed (FIG. 2).

In the sheet feeding portion 30, one sheet S is separated and fed from the sheets S loaded on the loading tray 31 by the supply roller 32 at a predetermined timing, and is conveyed toward the secondary transfer portion and the fixing apparatus 80.

In the secondary transfer portion, the toner image is transferred from the belt 41 to the sheet S. Toner that has not been transferred to the sheet S is removed from the belt 41 by a cleaning blade 43A as a cleaning member provided in the cleaning portion 43.

The toner removed from the belt 41 by the cleaning blade 43A is sent to a toner reception portion 43D due to the rotation of the toner stirring member 43C provided in the cleaning portion 43. A Mylar sheet is disposed in the toner stirring member 43C, and has a function of sending the toner to the toner reception portion 43D through rotation. The toner sent to the toner reception portion 43D is moved to an opening portion (not illustrated) provided at an end of the cleaning portion 43 via a toner conveyance path of the cleaning portion 43 through rotation of the screw 43B, which serves as a toner conveying member disposed in a depressed portion of the toner reception portion 43D. Specifically, the toner stirring member 43C and the screw 43B are rotated and driven through a gear train (not illustrated) from the drive roller 46, which is a member facing the cleaning blade 43A, and the toner moves toward the opening portion through the conveyance path in a direction parallel to the rotation axis direction. The opening portion is connected to a waste toner container disposed in the body, and the toner is collected in the waste toner container. The opening portion has an opening and closing mechanism that is open in a state where the transfer unit is mounted on the apparatus and closes in other states, thereby preventing toner leakage from the transfer unit. The waste toner container is disposed to be replaceable separately from the transfer unit.

The sheet S to which the toner image has been transferred in the secondary transfer portion is conveyed toward the fixing apparatus 80. In the fixing apparatus 80, the sheet S is heated and pressurized in the fixing portion 81, and the toner image is fixed to the sheet S. The sheet S, to which the toner image has been fixed, is conveyed toward the flapper 5, which serves as a path switching portion. The flapper 5 is movable between a discharge position at which the sheet S that has passed through the fixing apparatus 80 is guided toward the sheet discharge path 1d and a reversing position at which the sheet S is guided toward a reversing path 1e.

When single-sided printing in which an image is formed on one side of the sheet S is performed, the sheet S is guided to the sheet discharge path 1d by the flapper 5 and discharged to a discharge tray 1f formed in an upper portion of the apparatus body 1A.

On the other hand, when double-sided printing in which images are printed on the one side and the other side of the sheet S is performed, the sheet S is guided to the reversing path le by the flapper 5. After the sheet S is guided to the reversing path le, a conveying direction of the sheet S is reversed, and the sheet S is conveyed toward the secondary transfer portion through the double-sided conveyance path 20a formed in the door 20. In the secondary transfer portion, after the toner image is transferred to the other side of the sheet S, the sheet S passes through the fixing apparatus 80, is guided to the sheet discharge path 1d by the flapper 5, and is discharged to the discharge tray 1f of the apparatus body 1A.

### Lifetime of Cartridge and Transfer Unit

Generally, the number of printable sheets is preset as the lifetime in the cartridge and the transfer unit, and when a predetermined number of sheets is reached, the end of the lifetime is detected and the respective units are replaced. Factors that determine the number of printable sheets include, for example, a toner capacity, a lifetime of the developing roller, contamination of the charging roller, and wear of a front surface of the drum in the case of a cartridge. As a guideline, the lifetime of the cartridge is set to a length allowing printing of a predetermined number of sheets when printing is performed under predetermined conditions and at a print rate.

The lifetime of the developing roller may be set, for example, on the basis of the number of rotations of the developing roller. A degree of wear of the front surface of the photosensitive drum may be estimated, for example, by the number of rotations of the photosensitive drum, and the number of rotations at which a degree of wear reaches a limit may be set as the lifetime of the photosensitive drum.

Similarly, the lifetime of the transfer unit is set within a range in which an increase in wear or resistance value of constituent members is tolerable (for example, a range in which image defects such as transfer failure do not occur). Here, the lifetime is defined by printable sheets, but the lifetime may also be defined, for example, by a total rotation time or total rotation distance of the transfer roller or belt. An increase in resistance value of members such as the transfer roller or belt, for example, may be detected, and the lifetime may also be defined so that a detection result is in a range in which the image defects such as transfer failure do not occur. The control portion 3 can store information about the usage situation or lifetime of each cartridge P. The information on the usage situation of the cartridge P includes information on a usage history of the cartridge P. In this case, at least a part of the information on the usage situation or the lifetime of each cartridge P may be stored in a memory mounted on the cartridge P. In other words, a part of the control portion 3 (more specifically, a part of a storage device of the control portion 3) may be included in the cartridge P.

The transfer unit lifetime may be set to be longer than the cartridge lifetime. In the present example, the cartridge lifetime is set to 30K sheets or a rotation time equivalent to the 30K sheets, and the transfer unit lifetime is set to 150K sheets or a rotation time equivalent to the 150K sheets. Thus, an actual timing at which the end of lifetime is reached varies depending on printing conditions, but each cartridge is replaced by reaching the end of the lifetime four to five times before the transfer unit approximately reaches the end of the lifetime.

The printer 1 includes at least one processor (for example, a central processing unit (CPU)) as the control portion 3. Further, the printer 1 includes at least one storage device as the control portion 3. The storage device includes a random access memory (RAM) or a read-only memory (ROM). The control portion 3 can detect whether the cartridge P or the transfer unit 40 has reached the end of the lifetime, based on the usage situation of the cartridge P and the transfer unit 40 described above. The apparatus body 1A is provided with a display portion (not illustrated) for displaying various types of information to a user. When the control portion 3 detects the end of the lifetime, the control portion 3 displays, on the display portion, that the cartridge P or the transfer unit 40 has reached the end of the lifetime, and displays a message for prompting the user to replace the cartridge P or the transfer unit 40. These displays may be performed on the external host apparatus 400 as a display portion. In this case, the external host apparatus 400 can be called a part of the printer 1, and it can also be said that the printer 1 and the external host apparatus 400 form a printer system (image forming system).

### Replacement of Cartridge and Transfer Unit

Here, an image forming apparatus according to a comparative example configured so that the cartridge and the transfer unit are replaced at a timing when the cartridge and the transfer unit need to be replaced will be described. In a configuration of the comparative example, when the cartridge reaches the end of the lifetime, the tray is pulled out and the cartridge is replaced. When the transfer unit has not yet reached the end of the lifetime at the timing, the transfer unit does not need to be replaced and remains inserted in the apparatus.

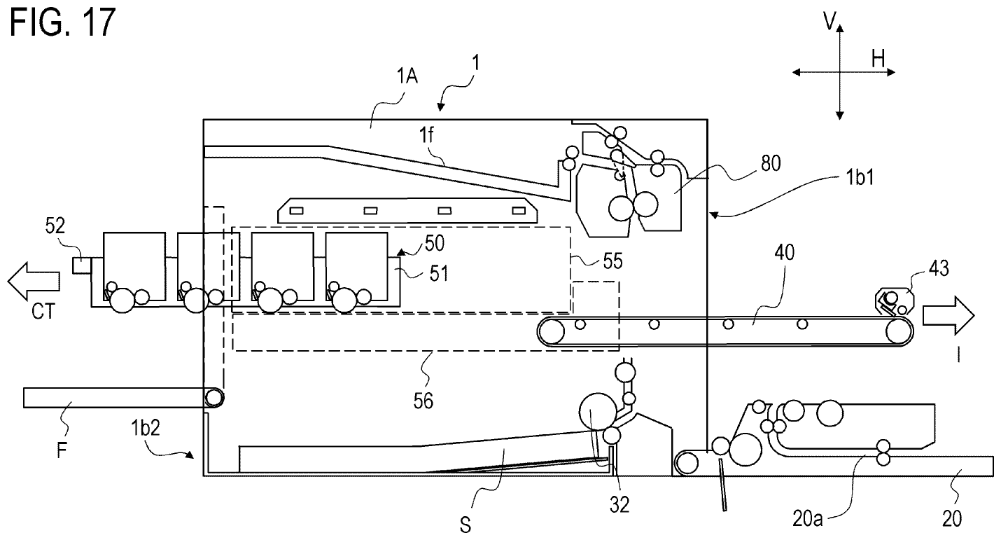

FIG. 17 is a diagram illustrating an example of an operation when the cartridge and the transfer unit are replaced in the comparative example configuration. Areas indicated by dotted lines 55 and 56 in the figure indicate mounting positions when the tray and the transfer unit are inside of the apparatus. In this configuration, when the cartridges are replaced, a door F is open, the tray is pulled out in a direction of an arrow CT, and each cartridge that needs to be replaced is replaced. In this case, the transfer unit remains at the mounting position. On the other hand, when the transfer unit is replaced, the door 20 is open and the tray is pulled out in a direction of an arrow I and replaced. Further, here, a movement direction of the tray and a movement direction of the transfer unit are different. This is because, when the tray is moved in the same direction as the movement direction of the transfer unit, a part of the transfer unit, in this case, a cleaner unit portion (cleaning portion 43) overlaps a trajectory of the tray insertion and removal so that the tray alone cannot be pulled out.

In the present example, when the cartridge is replaced, the transfer unit also moves with the movement of the tray even when the transfer unit has not yet reached the end of the lifetime, unlike the comparative example described above. In other words, when the tray unit 50 moves between the first inner position and the first outer position, the transfer unit 40 also moves between the second inner position and the second outer position in conjunction with such a movement.

### Removal of Tray Unit and Transfer Unit

The movement of the transfer unit at the time of replacing the cartridge in the present example will be described. In the present example, when the user moves the tray unit 50 from the first inner position to the first outer position relative to the apparatus body 1A, the transfer unit 40 also moves from the second inner position to the second outer position relative to the apparatus body 1A. In other words, the tray unit moves from the first inner position to the first outer position and the transfer unit 40 moves from the second inner position to the second outer position in a state where the transfer unit 40 and the tray unit 50 are integrated.

The transfer unit 40 supports the tray unit 50 from below the tray unit 50 in a state where the tray unit 50 is at the first outer position and the transfer unit 40 is at the second outer position.

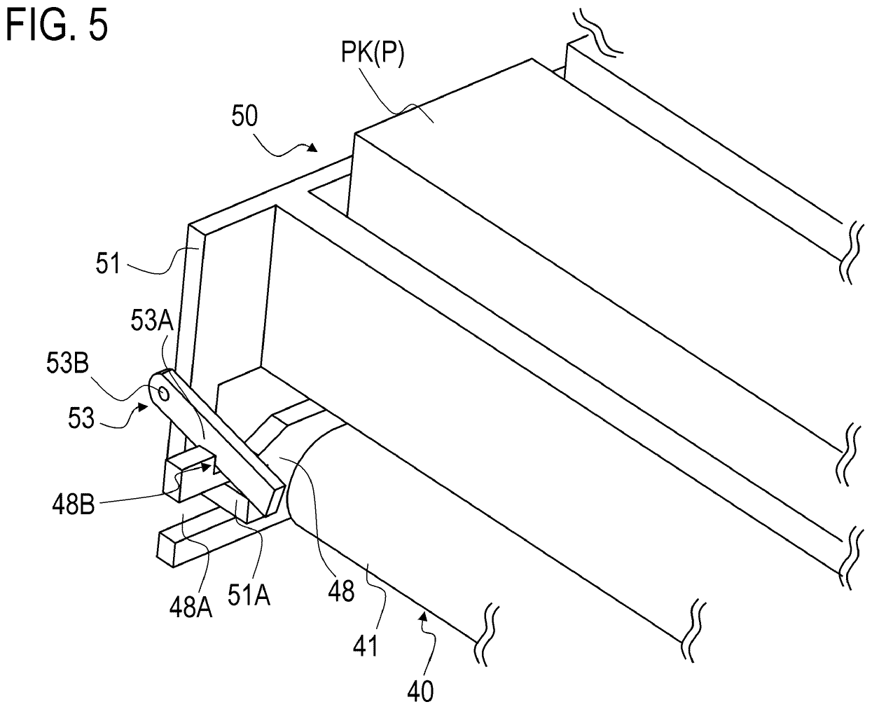

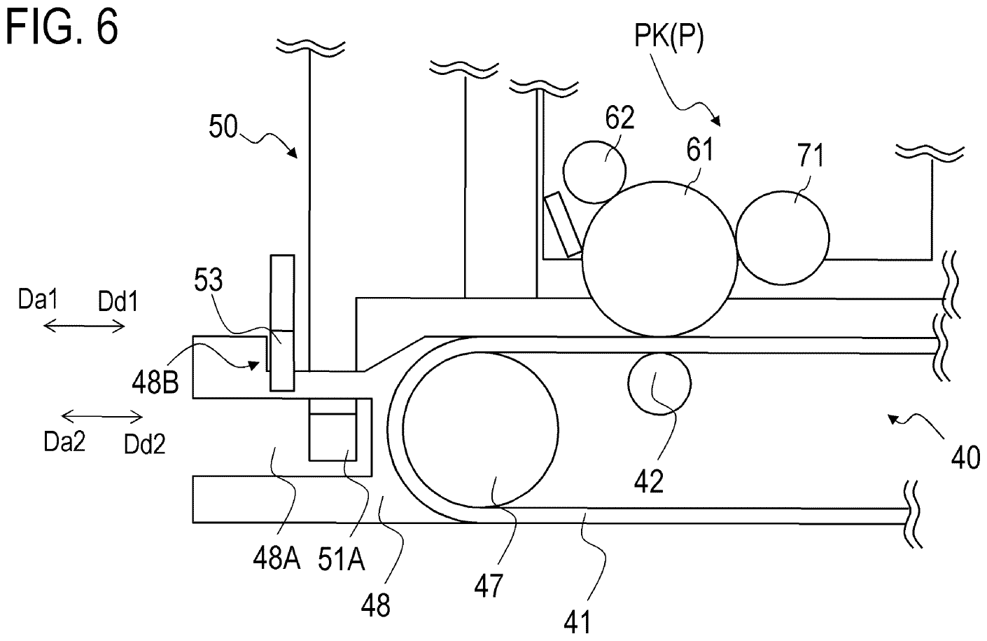

A configuration for moving the tray unit 50 and the transfer unit 40 in an integrated manner will be described with reference to FIGS. 5, 6, and 7. FIGS. 5, 6, and 7 are diagrams for explaining connection members (a lever, a stopper, and a lock member) 53 that connect the tray 51 of the tray unit 50 to the transfer unit 40.

The printer 1 according to the present example includes a lock member 53. In the present example, the lock member 53 is provided on the tray 51 of the tray unit 50. The lock member 53 has a transfer lock portion 53A and is rotatable around a rotation axis 53B. The tray 51 includes a transfer connection portion 51A. The transfer unit 40 includes a transfer frame 48 that supports the drive roller 46, the tension roller 47, and the primary transfer roller 42. The transfer frame 48 includes a tray connection groove 48A and a lock connection portion 48B.

When the lock member 53 rotates about the rotation axis 53B, the transfer lock portion 53A engages with the lock connection portion 48B, allowing a movement between a connection position at which the transfer unit 40 is connected to the tray unit 50 and a release position retracted from the connection position. Similar configurations are provided in a total of four locations near both ends of the tension roller 47 in a rotation axis direction of the tension roller 47 and near both ends of the drive roller 46 in the rotation axis direction of the drive roller 46.

When the transfer lock portion 53A of the lock member 53 at the connection position engages with the lock connection portion 48B, the tray unit 50 is restricted from moving in the first attachment direction Da1 relative to the transfer unit 40. On the other hand, the transfer unit 40 is restricted from moving in the second removal direction Dd2 relative to the tray unit 50. The lock member 53 and the lock connection portion 48B may also be provided at both ends of the transfer unit 40 in the rotation axis direction of the tension roller 47.

Thus, when the transfer connection portion 51A engages with the tray connection groove 48A and the lock member 53 at the connection position engages with the lock connection portion 48B, the transfer unit 40 and the tray unit 50 are restricted from moving relative to each other. In other words, it can be said that the transfer connection portion 51A and the lock member 53 function as a tray side connection device, and the tray connection groove 48A and the lock connection portion 48B function as a transfer side connection device. When the tray side connection device is connected to the transfer side connection device, the tray unit 50 is connected to the transfer unit 40, and the tray unit 50 and the transfer unit 40 move in an integrated manner.

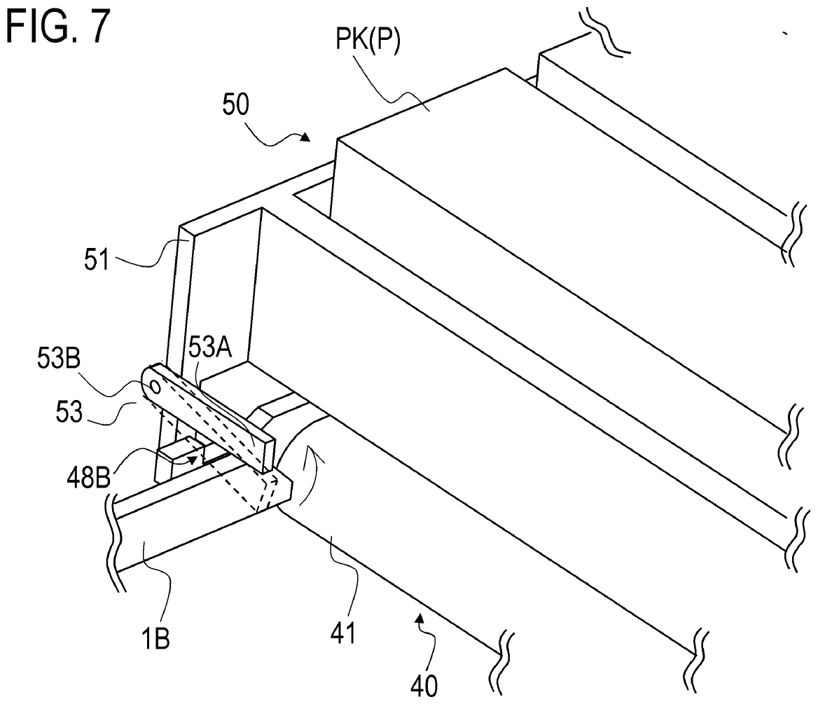

On the other hand, as illustrated in FIG. 7, the apparatus body 1A includes a lock release portion 1B. The lock member 53 comes into contact with the lock release portion 1B and is at the release position in a state where the tray unit 50 is at the first inner position and the transfer unit 40 is at the second inner position. In this state, the transfer lock portion 53A is separated from the lock connection portion 48B.

When the tray unit 50 is moved in the first removal direction Dd1 in a state where the lock member 53 is at the release position, the transfer unit 40 is pushed in the second removal direction Dd2 by the transfer connection portion 51A provided in the tray 51. As a result, the transfer unit 40 is also moved in the second removal direction Dd2 in an integrated manner with the tray unit 50. When the tray unit 50 moves a predetermined distance in the first removal direction Dd1, the lock member 53 is separated from the lock release portion 1B, moves to the connection position, and engages with the lock connection portion 48B. The tray unit 50 is moved to the first outer position and the transfer unit 40 is moved to the second outer position in a state where the lock member 53 is at the connection position and engages with the lock connection portion 48B.

When the tray unit 50 is moved in the first attachment direction Da1 in a state where the lock member 53 engages with the lock connection portion 48B, the transfer unit 40 is pushed in the second attachment direction Da2 by the lock member 53. As a result, the transfer unit 40 is also moved in the second attachment direction Da2 in an integrated manner with the tray unit 50.

When the transfer unit 40 is moved in the second attachment direction Da2 in a state where the lock member 53 engages with the lock connection portion 48B, the transfer unit 40 pushes the transfer connection portion 51A, and the tray unit 50 is pushed in the first attachment direction Da1. As a result, the tray unit 50 is also moved in the first attachment direction Da1 in an integrated manner with the transfer unit 40.

In the present example, in a state where the tray unit 50 is at the first inner position, the tray unit 50 is positioned with respect to the apparatus body 1A independently of the transfer unit 40. Further, in a state where the transfer unit 40 is at the second inner position, the transfer unit 40 is positioned with respect to the apparatus body 1A independently of the tray unit 50. This is because priority is given to accurately positioning the transfer unit 40 and the tray unit 50 with respect to the apparatus body 1A. Therefore, in a state where the tray unit 50 is at the first inner position and the transfer unit 40 is at the second inner position, a small clearance is provided between the tray connection groove 48A and the transfer connection portion 51A.

When the tray unit 50 and the transfer unit 40 are moved in an integrated manner toward the inside of the apparatus body 1A, the lock member 53 is moved to the release position by the lock release portion 1B. In this state, even when the tray unit 50 is moved in the first attachment direction Da1, the transfer unit 40 does not move. In other words, in a state where the tray unit 50 is pushed into the first inner position, the transfer unit 40 has not yet reached the predetermined second inner position.

Therefore, the transfer unit 40 is pushed in the second installation direction Da2 by a force with which the secondary transfer roller 45 comes into contact with the transfer unit 40 in a process of closing the door 20 which is an opening and closing member, is pushed to the back of the apparatus body 1A (the second inner position), and is positioned. In other words, the transfer unit 40, which is stationary before the second inner position, is pushed to a predetermined position due to an operation of closing the door 20, and in this process, an acceleration is applied to the transfer unit 40 so that the vibration is applied. Further, although the secondary transfer roller 45 pushes the transfer unit 40 in the process of closing the door 20, the door 20 may be provided with, for example, a member that pushes the transfer frame 48 of the transfer unit 40 to push the transfer unit 40.

On the other hand, when the transfer unit 40 is moved in the second removal direction Dd2 in a state where the lock member 53 is at the release position and the tray unit 50 is at the first inner position, the transfer unit 40 can move from the second inner position to the second outer position independently of the tray unit 50. In the printer 1 in the present example, the transfer unit 40 can be moved to the outer side (the second outer position) of the apparatus body 1A in a state where the tray unit 50 is located on the inner side (the first inner position) of the apparatus body 1A, as illustrated in FIG. 4. The transfer unit 40 is removable from the apparatus body 1A and can be replaced with a new transfer unit 40.

The present example adopts a configuration in which the tray unit 50 and the transfer unit 40 are configured to be positioned independently, but the present disclosure is not limited to such a configuration. A clearance between the tray connection groove 48A and the transfer connection portion 51A may be eliminated so that the tray unit 50 and the transfer unit 40 can be positioned relative to each other in a state where the tray unit 50 is at the first inner position and the transfer unit 40 is at the second inner position. In this case, the transfer unit 40 and the tray unit 50 can be positioned with high precision relative to each other.

### Waste Toner Conveyance Performance

For example, when the printer 1 is used continuously, a large amount of waste toner and paper dust are collected in the cleaning portion 43. When high print rate images continue, a large amount of waste toner is sent, and when low print rate images continue, a large amount of paper dust is sent to the toner. In particular, when such a state continues for a long period of time or when the apparatus is used in a high humidity environment, a load on the screw 43B in the cleaning portion 43 may increase, toner conveyance performance may gradually deteriorate, and problems such as hardening of toner and paper dust inside of the cleaning portion 43 may occur.

Specifically, since the screw 43B rotates to convey the toner sent to the toner reception portion 43D, there is a slight clearance between the toner reception portion 43D and the screw 43B to prevent interference, wear of members, friction noise, and the like at the time of rotation. Therefore, for example, when the use in a high humidity environment is continuous, the fluidity of the toner or paper dust decreases due to moisture absorption, and thus, it is easy for the toner to be retained near the screw 43B, for example, between the screw 43B and a wall member of the cleaning portion 43. When this state continues for a long period of time, a sliding torque may gradually increase. In this case, since a torque of the screw 43B gradually increases due to durability (long-term use), various measures may be required to prevent a drive gear that drives the screw 43B from being skipped or damaged at the end of the lifetime of the transfer unit 40.

Therefore, the printer 1 of the present example includes a configuration for applying vibration to the toner as a means for preventing the toner and paper dust retained in the cleaning portion 43 from being hardened and preventing the torque of the screw 43B from increasing. Specifically, the transfer unit 40 is inserted or removed simultaneously in conjunction with an insertion or removal operation of the tray unit 50 when the cartridge is replaced, so that the vibration is applied to the toner in the cleaning portion 43. Thus, when the transfer unit 40 is inserted or removed or when the door 20 is closed, the vibration is periodically applied to the unit and the internal toner due to an acceleration that occurs at the time of state transition from a stationary state to a moving state. This makes it possible to gradually loosen and circulate the toner before the toner hardens, thereby preventing the toner from being retained, stabilizing toner conveyance, and curbing an increase in torque.

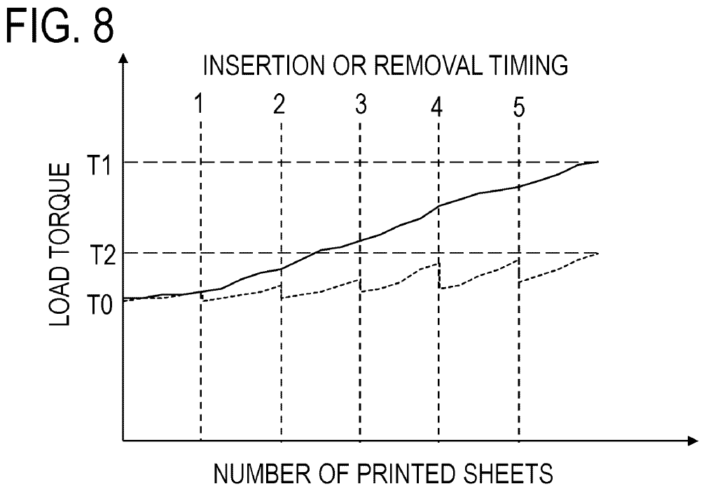

FIG. 8 is a graph showing a comparison in transition of a load torque of the screw 43B between the present example and the comparative example. In this graph, a transition of the load torque of the screw 43B in the case of a configuration of the comparative example in which the transfer unit 40 is not inserted or removed until the end of the lifetime is reached is indicated by a solid line. The transition of the load torque of the screw 43B when the transfer unit 40 is inserted or removed at the same time as the insertion or removal operation of the tray unit 50 that is performed each time the cartridge is replaced is indicated by a dotted line.

In torque measurement, the torque is calculated by detecting a drive current of a motor. Specifically, a total torque is first calculated by detecting a current of a drive motor of the drive roller 46. At this timing, a current of the drive motor is detected again in a state where a drive gear train of the screw 43B is released, and the load torque of the screw 43B is calculated by obtaining a difference in current.

Here, T0 indicates an initial torque, T1 indicates a maximum achievable torque in the comparative example, and T2 indicates a maximum achievable torque in the present example. As can be seen from this graph, in the comparative example, the load torque gradually increases with durability (long-term use). Therefore, it was necessary to perform a drive design or a motor rating design in which no tooth skipping or toner conveyance failure occurs even at a maximum achievable torque T1. On the other hand, in the case of the present configuration in which the insertion or removal operation is performed periodically, it was confirmed that the torque is once decreased at each insertion or removal operation. Thus, it can be seen that the torque is once decreased at each insertion or removal operation, and a final torque is also lower than in the comparative example. Further, an example in which the insertion or removal operation is performed five times is described here, but in reality, the number of insertions or removals is five or more since each cartridge is replaced at a timing when the end of the lifetime is reached, and an effect of curbing an increase in torque due to the insertion or removal is further achieved.

When the configuration of the present example is adopted in this way, the transfer unit 40 and the tray unit 50 are inserted or removed in a state where the transfer unit 40 and the tray unit 50 are integrated, so that the transfer unit is also subjected to the insertion or removal operation at each cartridge replacement timing. Therefore, it is possible to apply a vibration associated with a plurality of movement operations such as the insertion and the removal within the lifetime of the transfer unit. This makes it possible to prevent the toner or paper dust from being retained near the screw or between the screw and the wall member for a long period of time and prevent the torque from increasing due to accumulation, unlike the example of the related art. Therefore, a drive torque can be decreased through durability (long-term use) compared to the example of the related art, making it possible to maintain stable toner conveyance, which in turn makes it possible to simplify a drive design and reduce a size of the apparatus due to a reduced motor rating.

### Example 2

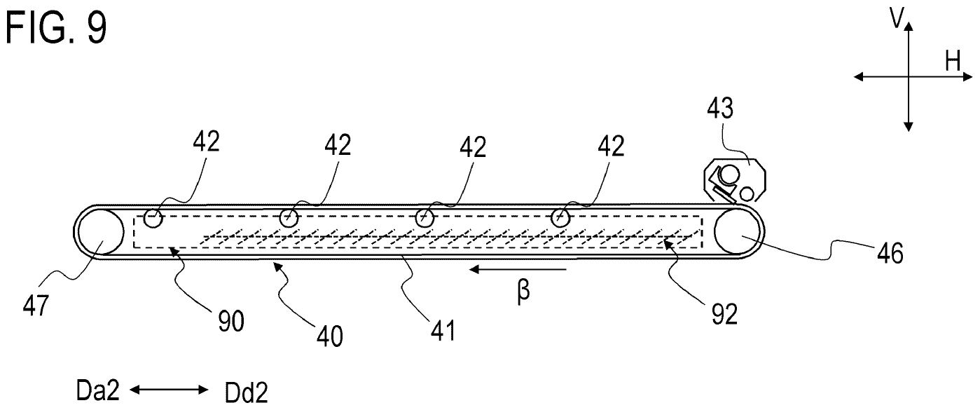

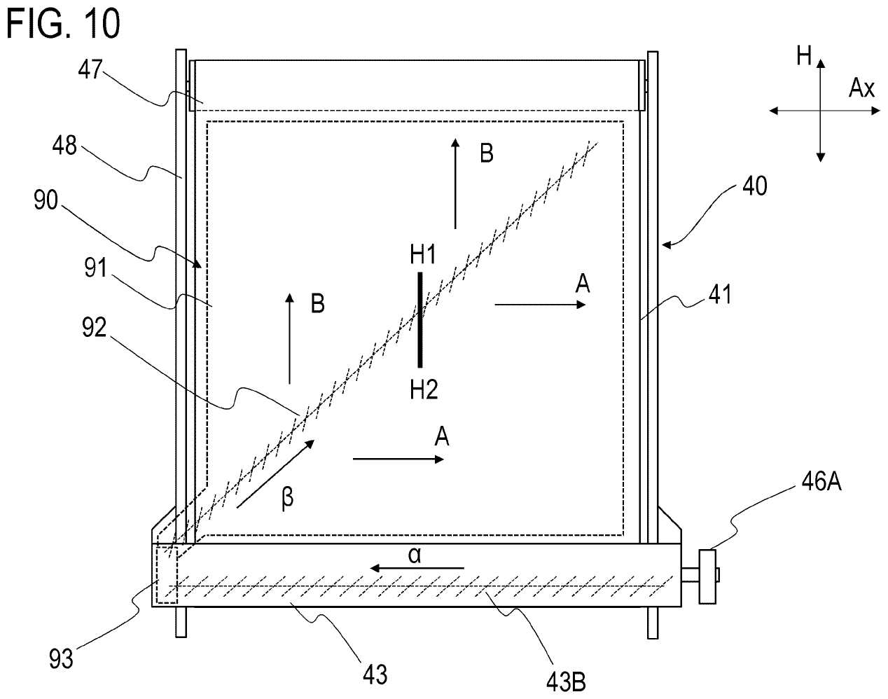

An image forming apparatus according to Example 2 of the present disclosure will be described using FIGS. 9 and 10. Here, differences between Example 2 and Example 1 will be mainly described, and components common to Example 2 and Example 1 are denoted by the same reference numerals and detailed description thereof will be omitted. In Example 2, a toner collection unit is integrated with the transfer unit 40. FIG. 9 is a view when the transfer unit 40 is viewed in the rotation axis direction of the photosensitive drum 61 or the like. FIG. 10 is a view when the transfer unit 40 is viewed from above in the vertical direction V. In FIGS. 9 and 10, members required for description, which are disposed in the transfer unit 40, are indicated by dotted lines.

A toner collection portion 90 is disposed inside of the transfer unit 40. In the transfer unit 40, the belt 41 has a continuous annular shape and is tensioned by the drive roller 46 and the tension roller 47, which are a plurality of rollers disposed on an inner side of the annular belt 41 (an inner side of the annular shape). A waste toner container 91, which serves as a toner accommodation portion, is disposed between the drive roller 46 and the tension roller 47 on the inner side of the annular belt 41 (the inner side of the annular shape) in the transfer unit 40. This toner collection portion 90 includes the waste toner container 91 for storing waste toner, and a conveyance screw 92 serving as a second conveying member that conveys the collected toner into the waste toner container 91. The conveyance screw 92 conveys the toner conveyed by the screw 43B serving as the first conveying member to the back of the waste toner container 91.

As illustrated in FIG. 9, a moving direction β of the toner conveyed by the conveyance screw 92 and the second attachment direction Da2 of the transfer unit 40 are approximately parallel when viewed in the rotation axis direction of the photosensitive drum 61 or the like.

As illustrated in FIG. 10, the toner collected by the cleaning blade 43A in the cleaning portion 43 is sequentially conveyed in an arrow direction α due to the rotation of the screw 43B and sent to an opening portion 93 provided at the end of the cleaning portion 43. The screw 43B is rotated through a gear by the rotation and drive of the drive roller 46. The drive roller 46 is rotated and driven by a gear 46A provided at the end being connected to the drive train of the body. The toner reaching the opening portion 93 is sent to an area of the conveyance screw 92 in the waste toner container 91 via the opening portion 93, and is sequentially sent in an arrow direction β due to the rotation of the conveyance screw 92. The conveyance screw 92 is also rotated through a gear by the rotation and drive of the drive roller 46.

The control portion 3 can store information about the usage situation or lifetime of each transfer unit 40. The information about the usage situation of the transfer unit 40 includes information about a usage history of the transfer unit 40. In this case, at least a part of the information about the usage situation or lifetime of each transfer unit 40 may be stored in a memory mounted on the transfer unit 40. In other words, a part of the control portion 3 (more specifically, a part of the storage device of the control portion 3) may be included in the transfer unit 40. In the present example, a volume of the waste toner container 91 is a volume that is sufficient to satisfy the lifetime of the transfer unit 40, that is, an accommodation amount that does not become full of toner before the transfer unit 40 reaches the end of the lifetime. Therefore, the lifetime of the transfer unit 40 is determined by lifetime of members constituting the transfer unit 40. In the present example, the number of printable sheets of the transfer unit 40 is preset. The control portion 3 determines that the lifetime has been reached when the number of printed sheets since the transfer unit 40 began to be used reaches the number of printable sheets, and notifies of the end of the lifetime.

When printing is performed in an image forming mode in which a lot of toner is consumed, like a solid black image, the toner in the cartridge runs out before the waste toner container 91 becomes full, and the cartridge needs to be replaced. Further, when printing of a low print rate image or solid white image (only toner is discharged) is performed, a rotation speed of the photosensitive drum or the developing roller reaches a lifetime rotation speed before the toner in the cartridge runs out and before the waste toner container 91 becomes full. Therefore, the tray unit 50 or the cartridge needs to be replaced. In other words, it can be said that, in either case, the lifetime of the transfer unit 40 is longer than the lifetime of the cartridge as long as the printer 1 is used in a normally assumed usage state.

A relationship between the lifetime of the transfer unit 40 and the lifetime of the cartridge will be described in more detail. A length of the lifetime of the cartridge P can be expressed as the number of sheets S printed from the start of use of a new cartridge P to detection or display of the end of the lifetime by the control portion 3. A length of the lifetime of the transfer unit 40 can be expressed as the number of sheets S printed from the start of use of a new transfer unit 40 to detection or display of the end of the lifetime by the control portion 3. In the present example, the length of the lifetime of the transfer unit 40 is longer than the length of the lifetime of the cartridge. Therefore, when a new cartridge P and a new transfer unit 40 are used at the same time, the number of sheets S printed before the new transfer unit 40 reaches the end of the lifetime is larger than the number of sheets S printed before the new cartridge P reaches the end of the lifetime.

Here, a mode in which the amount of toner consumed by the cartridge P per sheet S is maximized is called a maximum consumption mode, and a mode in which the amount of toner consumed by the cartridge P per sheet S is minimized is called a minimum consumption mode. In the present example, the length of the lifetime of the transfer unit 40 is larger than the length of the lifetime of the cartridge in both a case where printing is performed in the maximum consumption mode and a case where printing is performed in the minimum consumption mode. As described above, the volume of the waste toner container 91 is set to a volume sufficient to satisfy the lifetime of the transfer unit 40, that is, an accommodation amount that does not become full of toner before the transfer unit 40 reaches the end of the lifetime. Therefore, in the present example, the length of the lifetime of the transfer unit 40 is the same in the maximum consumption mode and the minimum consumption mode.

As described above, the control portion 3 can store information about the usage situation or the length of the lifetime of each cartridge P. The control portion 3 can store information about the usage situation and the length of the lifetime of each transfer unit 40. Further, functions of the control portion 3 may also be provided to the cartridge P or the transfer unit 40.

### Toner Conveyance State

The toner sent to the waste toner container 91 is gradually conveyed toward a right back direction (the direction of the arrow β) by the conveyance screw 92. Further, as new toner is sequentially sent from the opening portion 93, the toner retained near the conveyance screw 92 is pushed by the new toner, so that the toner is gradually sent in a direction of an arrow A and a direction of an arrow B and an entire area of the waste toner container 91 is filled with the toner. In other words, the toner sequentially supplied from the opening portion 93 pushes the toner that has already been sent, so that the toner spreads to the entire area of the waste toner container 91.

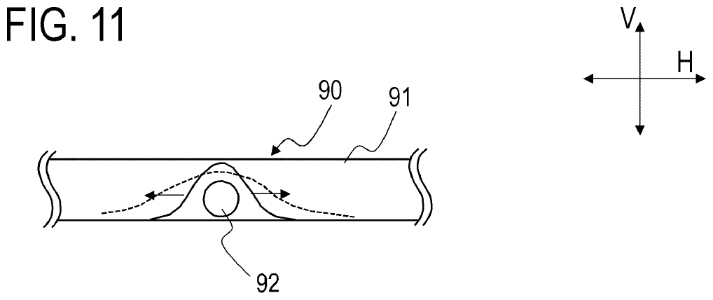

FIG. 11 is a schematic diagram illustrating s toner accumulation state when viewed from a drive roller rotation axis direction Ax in a case where a cross section is cut along a line indicated by H1-H2 in FIG. 10. A solid line in FIG. 11 indicates a toner retaining state near the conveyance screw 92 when waste toner continues to be sent under a predetermined condition. Further, a dotted line indicates a toner accumulation state when the insertion or removal operation is applied to the tray unit 50 and the transfer unit 40 from the state, specifically, after return to the state in FIG. 2 again through the state in FIG. 3 from the state in FIG. 2.

It was confirmed that the toner retained near the conveyance screw 92 spreads from the state indicated by the solid line to the state indicated by the dotted line due to the above operation, and the toner near the conveyance screw 92 decreases.

When the transfer unit 40 and the waste toner container 91 are integrated (in the present example, the transfer unit 40 includes the waste toner container 91), the waste toner container 91 needs to have a sufficient capacity to last the lifetime of the transfer unit 40 in advance.

As described above, the toner supplied sequentially from the opening portion 93 pushes the toner that has already been sent, so that the toner spreads to the entire area of the waste toner container 91. Therefore, when the toner is close to full, is retained near the conveyance screw 92, and is not pushed any further, a torque of the conveyance screw 92 begins to increase. Therefore, a configuration in which an upper limit torque value is set for the torque of the conveyance screw 92 and the waste toner being full is detected is also adopted here.

As described above, as an amount of toner in the waste toner container 91 increases, a toner conveyance torque gradually increases, and when the container is close to full, it becomes difficult for the toner to be pushed. The toner starts to be retained in the conveyance screw 92, a toner conveyance resistance increases, and a drive torque of the conveyance screw 92 suddenly increases.

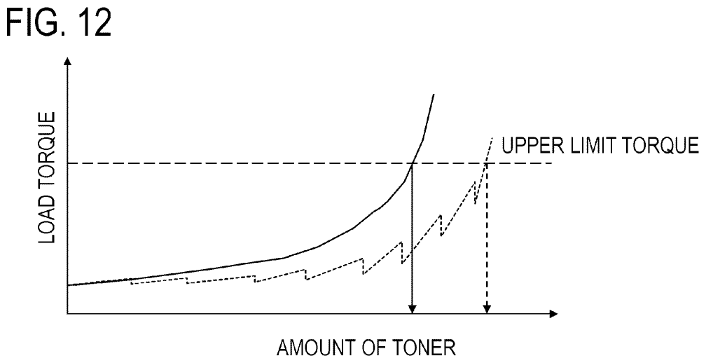

FIG. 12 illustrates a relationship between the amount of toner sent to the waste toner container 91 and the drive torque of the conveyance screw 92, with a solid line indicating a torque transition in the comparative example (no insertion or removal until the end of the lifetime) and a dotted line indicating a torque transition in the configuration of the present example (a plurality of insertion or removal operations are performed before the end of the lifetime).

It can be seen that, in the present example, a configuration in which vibration is applied due to insertion or removal at each cartridge replacement timing is adopted, an increase in torque is curbed, and a total amount of collected toner is increased, unlike the comparative example in which the transfer unit 40 is not inserted or removed until the waste toner is full. In particular, it can be seen that a previously increased torque is decreased and an increase in load torque is curbed each time the insertion or removal operation is performed. This is because the toner can be spread over a wide area each time the vibration at the time of the insertion or removal is applied as described in FIG. 11, making it possible to send the toner to an entire area in the waste toner container 91. As a result, a toner filling rate is improved, and an amount of toner that can be accommodated can be increased. As a result, a timing at which an upper limit torque is reached can be delayed.

Thus, since it is possible to periodically apply the vibration to the transfer unit 40 by adopting the configuration of the present example, it is possible to increase the amount of collected waste toner, to mitigate an increase in waste toner conveyance torque, and to delay the timing at which the upper limit torque is reached. This makes it possible to reduce a size of the waste toner container by improving a waste toner filling rate, and further to reduce sizes of the transfer unit and the apparatus.

### Example 3

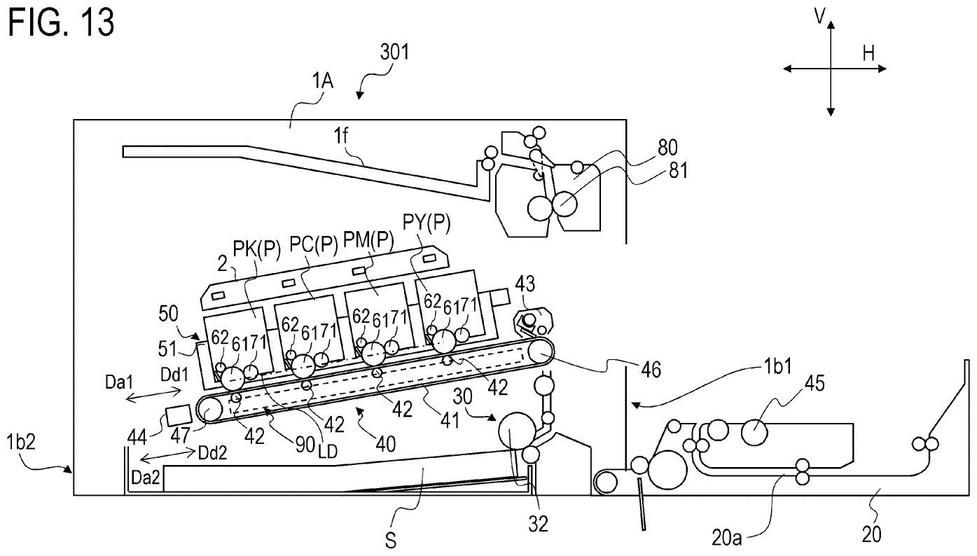

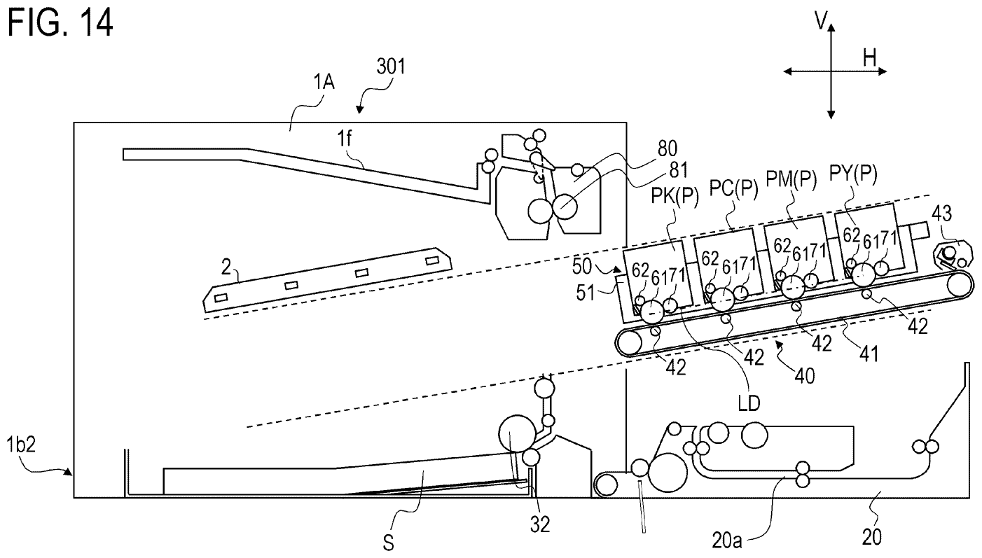

A printer 301 as an image forming apparatus according to Example 3 of the present disclosure will be described with reference to FIGS. 13 and 14. Here, differences between Example 3 and Examples 1 and 2 will be mainly described, and components common to Example 3 and Examples 1 and 2 will be denoted by the same reference numerals and detailed description thereof will be omitted. FIG. 13 is a diagram illustrating an overall configuration of the printer 301 according to Example 3, and shows the printer 301 in a state where the door 20 open. FIG. 14 is a diagram illustrating the printer 301 in a state where the transfer unit 40 and the tray unit 50 are pulled out.

In Examples 1 and 2, a configuration in which the tray unit 50 and the transfer unit 40 are disposed horizontally in a state where the tray unit 50 and the transfer unit 40 are mounted on the apparatus body 1A has been described. In Example 3, the tray unit 50 and the transfer unit 40 are inclined with respect to the horizontal direction H in a state where the tray unit 50 and the transfer unit 40 are mounted on the apparatus body 1A, as illustrated in FIGS. 13 and 14.

More specifically, the rotation axis of the photosensitive drum 61 closest to the first end 1b1 is located higher in the vertical direction V than the rotation axis of the photosensitive drum 61 farther from the first end 1b1 in a state where the tray unit 50 is at the first inner position. In other words, the second photosensitive drum is closer to the first end 1b1 than the first photosensitive drum, and a rotation axis of the second photosensitive drum is located higher in the vertical direction V than a rotation axis of the first photosensitive drum in a state where the tray unit 50 is at the first inner position. Similarly, the third photosensitive drum is closer to the first end 1b1 than the second photosensitive drum, and a rotation axis of the third photosensitive drum is located higher in the vertical direction V than the rotation axis of the second photosensitive drum. The fourth photosensitive drum is closer to the first end 1b1 than the third photosensitive drum, and a rotation axis of the fourth photosensitive drum is located higher in the vertical direction V than the rotation axis of the third photosensitive drum.

Here, a straight line connecting the centers of the respective photosensitive drums 61 is defined as a straight line LD. In the present example, when the tray unit 50 is at the first inner position, the straight line LD is inclined upward with respect to the horizontal direction H from the side farther from the first end 1b1 to the side closer to the first end 1b1.

Further, a contact surface of the belt 41 that comes into contact with the first, second, third, and fourth photosensitive drums is inclined upward from the side farther from the first end 1b1 to the side closer to the first end 1b1. That is, the drive roller 46 serving as a first roller that supports the belt 41 on the side closer to the first end 1b1 (first side) is disposed at a higher position than the tension roller 47 serving as a second roller that supports the belt 41 on the side closer to the second end 1b2 (second side). In the direction in which the transfer unit 40 moves from the second inner position to the second outer position, the drive roller 46 is located downstream of the tension roller 47, and the second outer position is located higher than the second inner position. When the tray unit 50 moves from the first inner position to the first outer position, the tray unit 50 moves in a direction inclined with respect to the horizontal direction H (in the present example, in a direction inclined upward with respect to the horizontal direction H). In other words, when the tray unit 50 moves from the first inner position to the first outer position, the tray unit 50 moves diagonally upward. Similarly, when the transfer unit 40 moves from the second inner position to the second outer position, the transfer unit 40 moves diagonally upward.

When the tray unit 50 moves from the first outer position to the first inner position, the tray unit 50 moves diagonally downward. When the transfer unit 40 moves from the second outer position to the second inner position, the tray unit 50 moves diagonally downward. With this configuration, it is possible to use weights of the tray unit 50 and the transfer unit 40 when inserting the tray unit 50 and the transfer unit 40 into the apparatus body 1A. Therefore, an acceleration is more easily applied at the time of mounting than in the case of horizontal disposition, and it is possible to apply vibration to the transfer unit 40 at the time of inserting.

Further, when Example 2 is combined with Example 3, the toner sent by the conveyance screw 92 in the waste toner container 91 disposed in the transfer unit 40 is also sent diagonally downward in a direction parallel to the straight line LD toward the second end 1b2 from the first end 1b1. Thus, when the disposition is made so that a direction in which the transfer unit 40 is inserted and the toner conveying direction are approximately parallel and diagonally downward, an effect of acceleration in a direction of gravity is also obtained, in addition to a toner diffusion effect caused by the vibration addition when the transfer unit 40 is inserted as described in Example 2. Therefore, the toner in the waste toner container 91 can be diffused further in a back direction and efficient filling can be performed over an entire area.

### Example 4

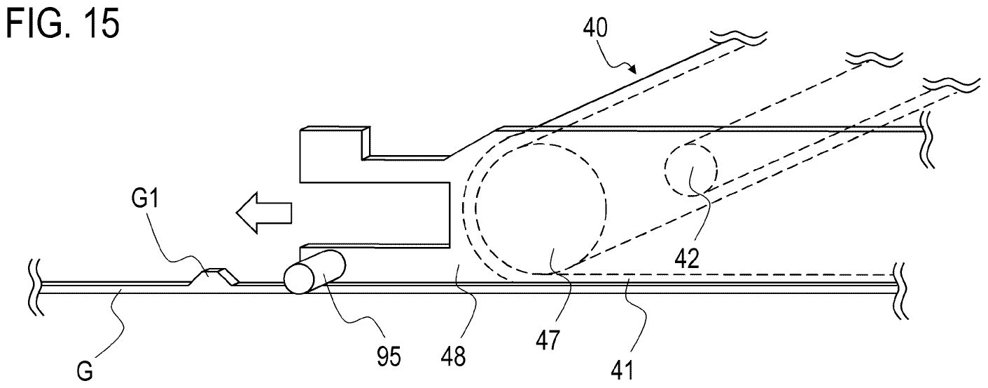

A printer as an image forming apparatus according to Example 4 of the present disclosure will be described with reference to FIG. 15. Here, differences between Example 4 and Examples 1, 2, and 3 will be mainly described, components common to Example 4 and Examples 1, 2, and 3 are denoted by the same reference numerals and detailed description thereof will be omitted. FIG. 15 is a perspective view illustrating the insertion and removal of the transfer unit 40 in Example 4.

In the apparatus body 1A, a guide rail member G is disposed as an insertion and removal guide member for guiding the insertion and removal of the transfer unit 40. The transfer unit 40 is inserted or removed along the guide rail member G at the time of insertion and removal. In the transfer unit 40, a guide pin 95 is provided as an insertion and removal auxiliary member (guided portion) for insertion, and is inserted or removed in an arrow direction in a state where the guide pin 95 is received by the guide rail member G.

In Example 4, a protrusion portion G1 is formed as a vibration applying portion in the guide rail member G, and the guide pin 95 climbs over the protrusion portion G1 when the transfer unit 40 is inserted or removed, thereby applying vibration to the transfer unit 40. When the transfer unit 40 moves so that the guide pin 95 climbs over the protrusion portion G1, the direction of movement of the transfer unit 40 temporarily changes while moving between the second inner position and the second outer position. A shape of the protrusion portion G1 here is a trapezoidal protrusion to make it easier for the guide pin 95 to ride over.

When a configuration in which the transfer unit 40 is inserted or removed by climbing over the protrusion portion G1 of the guide rail member G at the time of insertion or removal of the transfer unit 40 in this way is adopted, the vibration is applied in a V direction (vertical direction), in addition to the vibration in an H direction (insertion or removal direction). This makes it easier to apply the vibration at the time of insertion or removal, and obtain an effect of loosening the toner.

Here, a configuration in which one trapezoidal protrusion portion G1 is disposed in the guide rail member G has been described, but the shape or number of protrusions is not limited thereto. The protrusion portion G1 may be formed in any shape, and may also be formed in a depressed shape. Moreover, a plurality of protrusions may be installed.

Further, although an example in which the protrusion portion G1 is formed in the guide rail member G of the transfer unit 40 has been described here, a protrusion portion may also be provided similarly in an insertion and removal guide member (guide rail member) that is used when the tray unit 50 is inserted or removed.

### Modification Examples

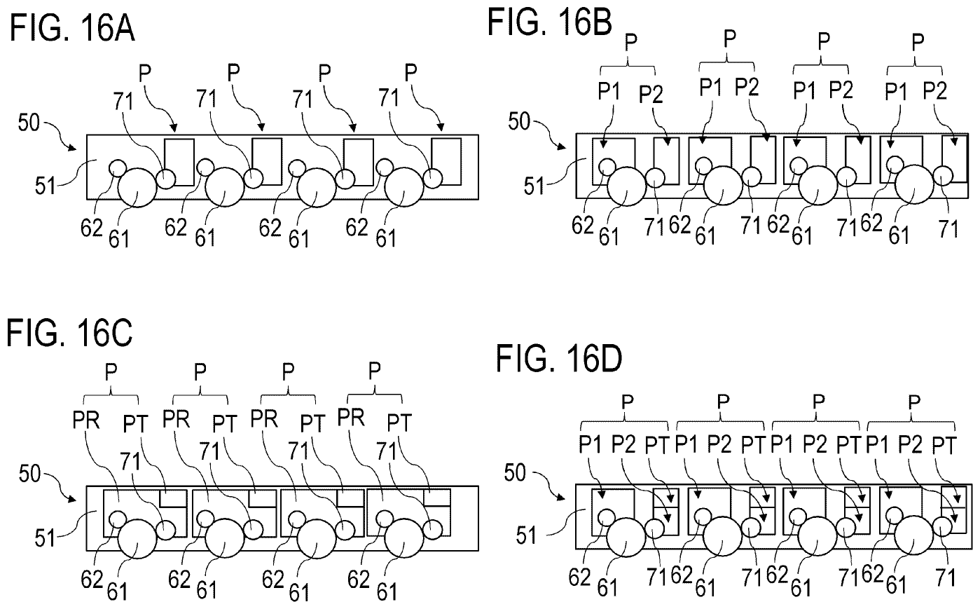

The photosensitive drum 61, the charging roller 62, and the developing roller 71 may be included in either the cartridge P or the tray 51. This will be described using FIGS. 16A to 16D. FIGS. 16A to 16D are diagrams illustrating a tray unit 50 according to a modification example.

For example, the tray 51 may include a photosensitive drum 61 and a charging roller 62, and the cartridge P may include a developing roller 71, as illustrated in FIG. 16A.

Also, the cartridge P may include a drum cartridge P1 having a photosensitive drum 61 and a charging roller 62, and a developing cartridge P2 having a developing roller 71, as illustrated in FIG. 16B. In other words, the cartridge P may be separable into the drum cartridge P1 and the developing cartridge P2. In this case, it is preferable for the drum cartridge P1 and the developing cartridge P2 to be detachable from the tray 51 independently of each other.

Further, the cartridge P may include a cartridge PR having the photosensitive drum 61, the charging roller 62, and the developing roller 71, and a cartridge PT having toner to be replenished to the cartridge PR, as illustrated in FIG. 16C. That is, the cartridge P may be separable into the cartridge PR and the cartridge PT.

Also, the cartridge P may include the drum cartridge P1, the developing cartridge P2, and the toner cartridge PT, as illustrated in FIG. 16D. The drum cartridge P1 includes the photosensitive drum 61 and the charging roller 62, the developing cartridge P2 includes the developing roller 71, and the toner cartridge PT includes toner to be replenished to the developing cartridge P2. That is, the cartridge P may be separable into the drum cartridge P1, the developing cartridge P2, and the cartridge PT.

In each Example, respective configurations can be combined with each other.

While the present disclosure has been described with reference to exemplary embodiments, it is to be understood that some embodiments of the disclosure are not limited to the disclosed exemplary embodiments. The scope of the following claims is to be accorded the broadest interpretation so as to encompass all such modifications and equivalent structures and functions.

This application claims priority to Japanese Patent Application No. 2024-038701, which was filed on Mar. 13, 2024 and which is hereby incorporated by reference herein in its entirety.

What is claimed is:

1. An image forming apparatus for forming an image on a recording material, comprising:
an apparatus body;
a cartridge;
a first unit to which the cartridge is detachably attached, the first unit being movable to a first inner position inside of the apparatus body and a first outer position outside of the apparatus body relative to the apparatus body; and
a second unit including a toner conveyance path and a conveying member configured to convey toner in the conveyance path, the second unit being movable to a second inner position inside of the apparatus body and a second outer position outside of the apparatus body relative to the apparatus body,
wherein a lifetime of the second unit is longer than a lifetime of the cartridge, and
in a case where the first unit moves from the first inner position to the first outer position, the second unit also moves from the second inner position to the second outer position.

2. The image forming apparatus according to claim 1, wherein a direction in which the second unit moves between the second inner position and the second outer position includes a direction inclined with respect to a horizontal direction.

3. The image forming apparatus according to claim 2, wherein the second outer position is higher than the second inner position.

4. The image forming apparatus according to claim 1, wherein a direction in which the second unit moves between the second inner position and the second outer position changes while moving between the second inner position and the second outer position.

5. The image forming apparatus according to claim 4, wherein
the apparatus body includes a guide rail configured to guide the movement of the second unit between the second inner position and the second outer position, and
the guide rail includes a vibration applying portion configured to apply vibration to the second unit.

6. The image forming apparatus according to claim 1, wherein
the apparatus body includes an opening through which the second unit passes, an opening and closing member that is movable to a closed position at which the opening is covered by the opening and closing member and an open position at which the opening is exposed, and
the second unit moving from the second outer position and reaching a position before the second inner position is configured to be positioned at the second inner position through an operation in which the opening and closing member moves from the open position to the closed position.

7. The image forming apparatus according to claim 4, wherein
the first unit includes:
a tray configured to be movable between the first inner position and the first outer position relative to the apparatus body;
a photoconductor configured to bear a toner image;
a developer bearing member configured to bear toner to be supplied to the photoconductor; and
a charging member configured to charge the photoconductor,
the second unit includes:
a belt onto which the toner image borne by the photoconductor is transferred;
a cleaning member configured to remove the toner from the belt;
the conveyance path for conveying the toner removed from the belt by the cleaning member; and
the conveying member,
at least one of the photoconductor, the developer bearing member, and the charging member is detachable from the tray as the cartridge, and
the apparatus body includes a transfer portion configured to transfer the toner image from the belt to the recording material.

8. The image forming apparatus according to claim 7, wherein
the belt has an annular shape,
the second unit includes
a plurality of rollers disposed on an inner side of the annular shape and configured to tension the belt; and
a toner accommodation portion configured to accommodate the toner conveyed by the conveying member, and
the toner accommodation portion is disposed on the inner side of the annular shape.

9. The image forming apparatus according to claim 8, wherein a toner accommodation amount of the toner accommodation portion is an accommodation amount in which it does not become full of toner before the second unit reaches the end of the lifetime.

10. The image forming apparatus according to claim 8, wherein
the conveying member is a first conveying member, and
the second unit includes a second conveying member disposed in an interior of the toner accommodation portion and configured to convey the toner conveyed from the first conveying member.

11. The image forming apparatus according to claim 10, wherein the plurality of rollers include:
a first roller configured to support the belt on a first side in a horizontal direction; and
a second roller configured to support the belt on a second side opposite to the first side in the horizontal direction,
wherein the cleaning member and the conveyance path are disposed on the first side in the horizontal direction,
wherein the toner accommodation portion is disposed between the first roller and the second roller on the inner side of the belt, wherein
the first roller is disposed at a higher position than the second roller, and
the first roller is located downstream of the second roller in a direction in which the second unit moves from the second inner position to the second outer position.

12. The image forming apparatus according to claim 1, wherein the second unit is configured to be movable from the second inner position to the second outer position in a state where the first unit is at the first inner position.
